(19) United States
(12) Patent Application Publication
(10) Pub. No.: US 2004/0217158 A1
(43) Pub. Date: Nov. 4, 2004

(54) Method for apparatus for message detection and selection

(75) Inventors: Bruno Wenger, AU (CH); Rolf Baechtiger, Oberwil-Lieli (CH)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS TRANSIT TELEMATIC SYSTEMS AG, NEUHAUSEN A. R. (CH)

(21) Appl. No.: 10/773,367

(22) Filed: Feb. 9, 2004

Related U.S. Application Data
(63) Continuation of application No. PCT/EP02/08128, filed on Jul. 22, 2002.

(30) Foreign Application Priority Data
Aug. 17, 2001 (EP) 01 119 905.6
Jan. 10, 2001 (EP) 01 123 555.3

(51) Int. Cl. G07B 15/00

(52) U.S. Cl. 235/33; 235/435; 340/10.1

(57) ABSTRACT

Electronic tickets are triggered by a trigger message, out of a standby state, for the determination of used capacity. In order to further reduce energy requirements, or to increase the autonomy of the tickets, a trigger message recognition and selection is disclosed, whereby firstly a trigger message is detected in a receiver and, subsequently, when information contained in a detected tigger message is destined for the relevant ticket, a processor module is activated by means of a switch. In a preferred embodiment, the activation is a multi-stage form, in which a digital filter is arranged between the receiver and processor module which can also be activated by a switch. The switch for activating the process module may be operated by the digital filter.

### CROSS REFERENCE TO RELATED APPLICATIONS

The present application is a continuation of international application PCT/EP02/08128, filed Jul. 22, 2002, which designated the United States, and further claims priority to European Patent Applications, EP0119905.6, filed Aug. 17, 2001 and EP01123555.3, filed Oct. 1, 2001, the above of which are incorporated herein by reference.

### BACKGROUND OF THE INVENTION

The present invention relates to a method and a circuit arrangement for wake-up message detection and selection. The present invention is concerned with the registration of objects in a delimited space for identifying a purchased service, which is also known as “electronic ticketing” or “fare management”.

Document WO 01/03057 A1 discloses a method for detecting objects by means of a transponder wherein, when a detection zone is entered, a first information unit is transmitted to the transponder, preferably in the 127 kHz frequency range, thereby waking up said transponder. In response to the information contained in the first information unit, a transmitting module present on the transponder is activated immediately or after a delay in order to transmit a second information unit at least once to a receiving unit located in the detection zone.

The method and system for registering tickets disclosed in document WO 01/20557 A1 differs in that a receiving module present on the ticket is “awakened” from a sleeping state by a first information unit and is periodically switched to active state. Bidirectional communication is established via further information units by a transceiver unit assigned to the detection zone and the relevant presence of a ticket is registered as a ticket record.

The “protocols de détection de la présence d'individus ou d'objets dans un espace délimité” [protocol for detecting the presence of an individual or an item within a confined space] mentioned in document EP 1 104 919 A1 is likewise based on the waking-up of a ticket when a detection zone is entered. Presence is then established by means of a distance measurement.

The common feature of the above systems is that although power consumption is significantly reduced with the waking-up and periodic activation of either the transmitting module or receiving module on the ticket compared to permanent activation, in many cases the ticket is woken up without subsequent registration being possible, as is the case with mere presence in a train station.

Document DE 199 52 840 A1“Data transmission for temporarily inactive receivers” specifies a method and a receiver wherein a receiver analyzes the contents of a received message, causing the receiver to be temporarily deactivated. This solution requires that the receiver be continuously ON at the start of the process.

In EP 0 766 215 A1 a method is disclosed by Texas Instruments Inc. wherein an electronic ticket can be woken up in various stages. For this purpose there is initially provided a level detector with which only messages of a defined minimum level result in initial activation. In a further step a check is performed so as to ascertain whether the received wake-up message exhibits the pre-determined modulation. If this modulation is deemed to be correct, another circuit section is activated and among other things an access code is checked, at a higher level, against a security code stored on the ticket.

### SUMMARY OF THE INVENTION

An object of the present invention is therefore to specify a method and a circuit arrangement for an electronic ticket wherein the power consumption is reduced by intermittent operation and wherein selective addressing of individual tickets is additionally possible, enabling messages to be selectively received by the tickets. This and other objects are achieved by the measures detailed below. The steps of the method according to the invention enable the activation of the processor module to be limited to the cases in which a message must actually reach the ticket in question, thereby minimizing the power requirement of the ticket.

This can additionally provide the following advantages, namely due to the fact that the information contained in the first and/or second memory can be modified, wake-up message selection can be dynamically controlled and/or configured.

The term “transponder” is also subsumed under the term “electronic ticket”, or “ticket” for short, used in this document.

### DETAILED DESCRIPTION OF THE SEVERAL VIEWS OF THE DRAWINGS

The present invention will now be described with reference to the accompanying drawings in which:

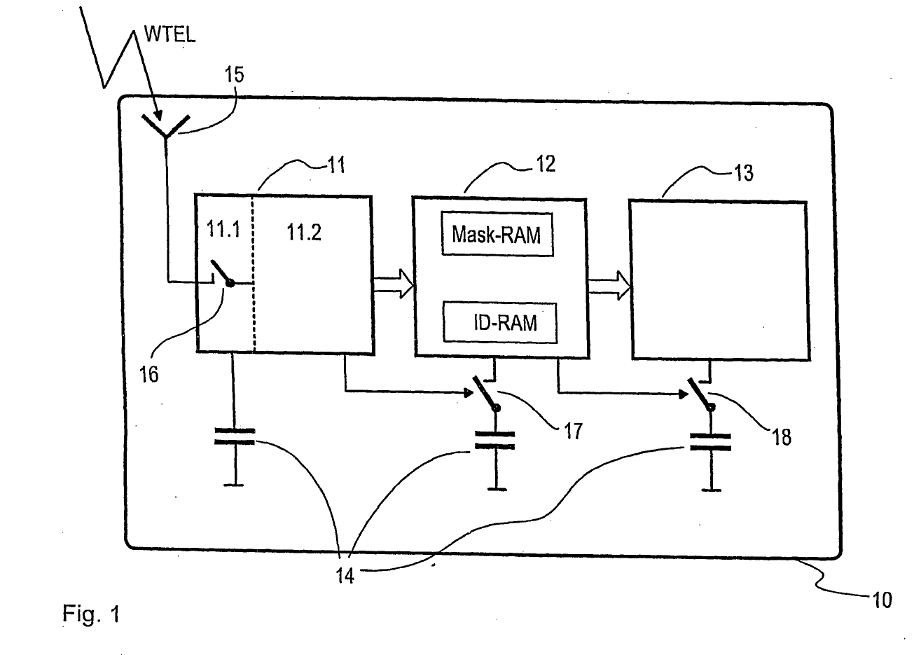

FIG. 1 depicts a block diagram of the circuit arrangement provided for wake-up message detection and selection; and

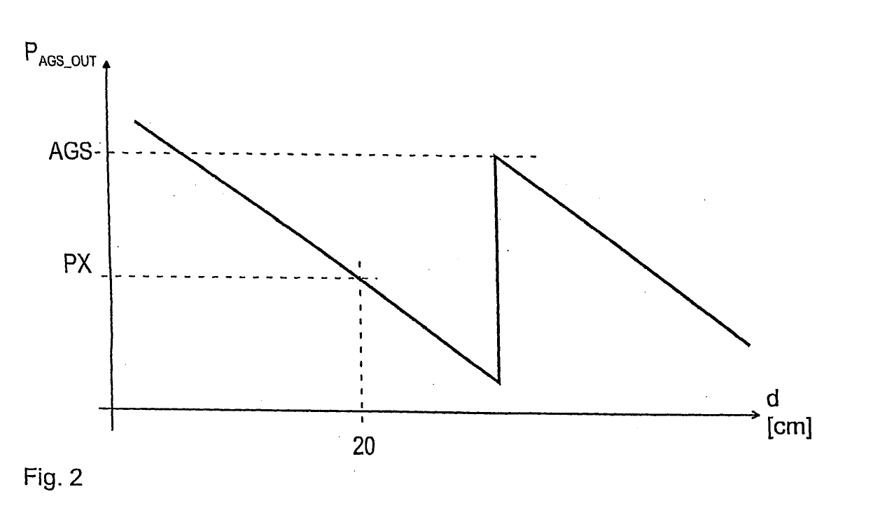

FIG. 2 depicts a simplified representation of the message level for proximity message detection.

### DETAILED DESCRIPTION OF THE INVENTION

FIG. 1 depicts an electronic ticket 10 with a circuit arrangement for wake-up message detection and selection. Wake-up messages WTEL are emitted at a frequency wherein the electromagnetic field is produced primarily in the near field. One possible frequency range is 7.68 MHz. For purposes of brevity, bidirectional communication circuits of the ticket have been omitted from FIG. 1. Bidirectional communication may occur in the 868 MHz frequency range.

The ticket 10 include ***contains an analog receiver 11, a digital filter 12, and an intelligent processor module 13 as components of the circuit arrangement. The digital filter 12 and the processor module 13 are selectively supplied by at least one power source 14. Here selective means that the two abovementioned units 12 and 13 are only supplied with power using the switches 17 and 18 if this is required in response to the wake-up message WTEL received. To facilitate a better understanding of the circuit arrangement according to the invention, the structure of a wake-up message WTEL will first be set out with reference to Tables 1, 2 and 3 below.

Wake-Up Message WTEL

TABLE 1

| | | | | | | | |
|---|---|---|---|---|---|---|---|
| SOF | H-Control | D-Length | Select | CRC8 | Data | CRC16 | EOF |

Table 1 shows the structure of a wake-up message WTEL having a defined number of bits. The start is designated SOF (Start Of Frame). This is followed by an information unit H-Control (H Header) whose structure is shown in Table 2. The represented sizes of the individual records do not correspond to the actual size in bits or bytes. Instead of an information unit, a person skilled in the art will also use the term record or field, these terms also being used recursively, meaning that a record can also contain other records. The information unit D-Length, e.g. 8 bits long, specifies the length of the actual useful information designated Data in the wake-up message WTEL. To safeguard the records SOF, H-Control, D-Length and Select, CRC8 provides a Cyclic Redundancy Check 8 which may be generated for examble by using the generator polynomial: 1+x²+x³+x⁴+x⁸.

To safeguard the content of the information transmitted in the information unit Data, at the end of the wake-up messages WTEL, a CRC16 (Cyclic Redundancy Check 16) is provided which may be generated by using the generator polynomial: 1+x⁵+x¹²+x¹⁶.

The end of the wake-up message WTEL is identified by the field EOF (End Of Frame) and may contain a bit pattern of defined length and if necessary of defined conditions concerning the individual bits, i.e. checksum mod 2 equals zero.

By way of example, Table 2 shows individual fields or records specifying on the one hand the type of wake-up message WTEL and on the other its general “handling” by the receiving ticket. Although the fields are all shown as having the same size, they are in practice of different sizes in respect of the number of bits. Under certain circumstances or for particular applications it may be necessary for the tickets 10 located within the range of a transceiver to receive and process a wake-up message WTEL in any event. To make this possible, there is provided in the H-Control record a flag FA which contains the information for forced reception of this kind. In another flag FB as shown in Table 2, the type or origin of the message can be specified, a proximity message signifying here that the message originates from a transmitting device having a range of up to approximately 20 cm. The meaning of this flag will be explained in connection with FIG. 2 below. Additional flags FC, FD and FE can be provided for further specifying the handling of the wake-up message WTEL, although this enumeration is not be taken in a limiting sense.

Information Unit H-Control

TABLE 2

| Information | |
|---|---|
| field | Meaning |
| H2 | H-Control length bit 2 |
| H1 | H-Control length bit 1 |
| H0 | H-Control length bit 0 |
| FA | Forced reception flag A: |
| | “Force Receive” or “Receive All” |
| FB | Proximity type message flag B |
| FC | Flag C |
| FD | Flag D |
| FE | Flag E |

The information unit Data shown in Table 3 contains the application data. In this exemplary embodiment, this is the data necessary for detecting the presence of an electronic ticket in a detection zone, e.g. in a railroad car.

Information Unit Data

TABLE 3

| Information | |
|---|---|
| field | Meaning |
| ADDRESS1 | Address of transceiver |
| CYCLE1 | Time unit, time reference; cycle |
| | time |
| COMMAND1 | Commands to the ticket 10 |
| POSITION1 | Location, entry point |
| COURSE1 | Route and/or car number |
| DATETIME1 | Date and time of day |
| TYPE1 | Type of transport |

In this embodiment, the field CYCLE1 is provided for intermittent bidirectional communication in the 868 MHz frequency range between a ticket 10 and a transceiver unit in the detection zone. It contains in particular the information for intermittent operation which is necessary in order to minimize power consumption. This intermittent bidirectional communication can be commenced on receipt of a wake-up message WTEL and is the basis for establishing a defined presence of a ticket 10 in a detection zone.

Now that the structure of the wake-up message WTEL has been explained, the method according to the invention will be explained with reference to the operation of the circuit arrangement illustrated in FIG. 1.

If a message of the specified frequency, e.g. 6.78 MHz, is fed from the antenna to the level detector 11.1, a connection to the demodulator 11.2 is established by means of a first (electronic) switch 16. A wake-up message WTEL is preferably OOK-modulated (On Off Keying), which means that the abovementioned SOF and EOF fields are available in the demodulator 11.2. This obviates the need for frame synchronization and so-called repetitive messages can be seamlessly transmitted in this way.

The abovementioned OOK modulation scheme is only one example, and other modulation schemes such as e.g. ASK (Amplitude Shift Keying) can also be used.

If a valid OOK-modulated wake-up message WTEL is now detected by the demodulator 11.2, a digital filter 12 is activated using a second (electronic) switch 17 and the demodulated wake-up message WTEL is fed to the filter 12.

In the digital filter 12, the abovementioned CRC8 protection and then CRC16 protection are checked, the field only being checked when the CRC8 protection produces a negative result, i.e. the transmitted header is deemed to be OK, and when a length greater than zero has been specified in D-Length for the CRC16 protection. If one of the abovementioned CRC8 or CRC16 checks yields a positive result, the wake-up message WTEL received in the filter 12 is rejected. The digital filter can assume the OFF state immediately or after a certain latency time. For further analysis of a received wake-up message WTEL in the filter 12, four parallel-operating search circuits (not shown in FIG. 1) may be provided. Each search circuit comprises a mask RAM which indicates or masks which bits or fields are to be compared, and an ID RAM (ID: identity) which indicates which values these bits or fields are expected to have. The analysis results of said search circuits are fed to a decoder logic circuit. This decoder logic contains information regarding the combinations of the abovementioned results for which a wake-up message WTEL is not to be fed to the processor module 16. The processor module 13 is activated by a third (electronic) switch 18 which can be actuated by the decoder logic. The decoder circuit also contains in particular the information that, e.g. when a flag FA is set, the corresponding wake-up message WTEL must be fed to the processor module 13 in any event. Another function of the digital filter 12 will now be explained with reference to FIG. 2. In order to ensure that a range of 0.1 cm to approximately 300 cm is possible in the receiver 11 for the same output power of a transceiver unit located in the detection zone, the receive sensitivity must be switchable in the receiver 11. This switching is performed by a two-stage AGS circuit (AGS: Automatic Gain Switch) contained in the receiver 11, i.e. the gain is dependent on the input level of the wake-up message WTEL, resulting in two different gains. FIG. 2 shows, along the ordinate, the level P_{AGS}_{_{—}}_{OUT} at the output of the AGS circuit as a function of the distance d of a ticket 10 from a transceiver unit. The switching threshold of the AGS circuit is given by PAGS. In certain applications it is necessary that only tickets 10 located in the immediate vicinity can be addressed with a wake-up message WTEL. This immediate vicinity is termed the proximity range here and encompasses a range of 0.2 cm to approximately 20 cm. An application of this kind arises, for example, when, at a passenger-operated transceiver unit, a particular item of information is to be transmitted to a ticket 10, e.g. the number of passengers or deactivation of the tickets 10 allocated to a father's currently non-accompanying children. It must be ensured that, specifically in a crowd situation, the tickets 10 of the other travelers are not thereby addressed. In addition to the wake-up message WTEL, information as to whether the AGS circuit is at the lower gain stage and whether the level PX specified in FIG. 2 has been exceeded is fed to the filter 12.

The abovementioned decoder logic can be of multi-stage design, whereby certain records or bits of the wake-up message WTEL are analyzed in parallel and the result of these first decoder logic circuits is fed to a second decoder logic circuit in which a message is then generated which is used for actuating the third switch 18.

In the processor module 13, the wake-up messages WTEL intended for the relevant ticket are stored and analyzed in respect of subsequent bidirectional communication at 863 MHz and 868 MHz.

In a particular embodiment of the present invention, the digital filter 12 can be configured by the processor module 13 in response to an item of information in the wake-up message WTEL or an item of information in the bidirectional communication. This means that the contents of the first memory (mask RAM) and/or of the second memory (ID RAM) can be modified by the processor module 13 in order to be able to subsequently obtain a specific new or modified selection of wake-up messages WTEL. For reconfiguring the digital filter 12, a wake-up message WTEL is preferably used for which the abovementioned flag FA has been set and for which a flag FC (C=Configuration) has additionally been set, and the data to be written to the first memory (mask RAM) and/or to the second memory (ID RAM) can be contained in the Data field. A person skilled in the art would term this a variant record in a case such as this.

The method steps for protecting and selecting the wake-up messages WTEL specified in the above embodiments are mutually independent and can therefore be combined as required.

The message detection and selection method according to the invention can also be used in other applications, e.g. for overload prevention enabling targeted and dynamically controllable selection to be performed for the feeding of messages to a processor system.

We Claim:

1. A method for wake-up message detection and selection by an electronic ticket, said ticket including a receiver connected to an antenna and a processor module, a level detector, and a demodulator and digital filter, comprising the steps of:
receiving a wake-up message;
detecting a level of said wake up message;
determining if said level meets a preselected value;
transmitting said wake up message to said demodulator if said level meets said value;
determining validity of said wake-up message, within said demodulator, said validity being defined by a modulation scheme;
transmitting said wake-up message to said digital filter if said wake-up message is determined as being valid;
establishing, within said digital filter, whether a wake-up message has been received for said ticket, said step of establishing comprising the steps of masking parts of said wake-up message, by means of first information contained in a first memory, and determining if said information matches second information contained in a second memory; and
activating said processor module if a match is determined between said first and second information.

2. The method according to claim 1, wherein said step of activating said demodulator further comprises the step of activating a first switch.

3. The method according to claim 1, wherein said step of activating said digital filter further comprises the step of activating a second switch.

4. The method according to claim 1, wherein said modulating scheme comprises one of a OOK and ASK modulating scheme.

5. The method according to claim 1, wherein said mask memory is a mask RAM.

6. The method according to claim 1, wherein said second memory is an ID RAM.

7. The method according to one of the claim 1, wherein said wake-up messages are modulated according to an On-Off Keying method and said wake-up messages are seamlessly transmitted without frame synchronization.

8. The method according to claim 1, further comprising the step of, after said step of activating, modifying said first and second information via said processor module.

9. The method according to claim 8, wherein said step of modifying said first and second information is performed in accordance with other information contained in said wake-up message.
